(19) United States
(12) Patent Application Publication
(10) Pub. No.: US 2004/0058249 A1
(43) Pub. Date: Mar. 25, 2004

(54) Mesh reinforced fuel cell separator plate

(76) Inventors: Yuqi Cai, Kingston (CA); Divya Chopra, Kingston (CA); Larin Godfroy, Napanee (CA); John C. Fisher, Kingston (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/318,451

(22) Filed: Dec. 13, 2002

Related U.S. Application Data
(60) Provisional application No. 60/413,316, filed on Sep. 25, 2002.

(51) Int. Cl. H01M 2/16

(52) U.S. Cl. 429/248; 429/247; 429/129; 429/135; 429/145

(57) ABSTRACT

Separator plates for use in a fuel cell comprising a conductive polymeric composite that is reinforced with an electrically conductive mesh or screen, and a method for making the reinforced separator plates.

### FIELD OF THE INVENTION

The present invention relates to improved electrically conductive flow field separator plates for use in proton exchange membrane fuel cells and to methods of making such plates. In particular, the plates of the present invention include a conductive polymeric composite reinforced with an electrically conductive mesh or screen.

### BACKGROUND OF THE INVENTION

A typical proton exchange membrane (PEM) fuel cell comprises several components. These components include:

a polymeric electrolytic membrane, such as DuPont's NAFION® membrane, which is the heart of the fuel cell and conducts protons from the anode to the cathode,

catalyst layers on the anode and cathode sides of the membrane known as the gas diffusion electrodes,

gas diffusion backings on each side, and

separator plates (also called conductive plates, collector plates, bipolar plates, or flow field plates) at the anode and the cathode.

The membrane, gas diffusion electrodes and gas diffusion backings are typically laminated together to create the membrane electrode assembly (MEA). Each MEA is sealed between two thermally and electrically conducting separator plates to form a PEM fuel cell. Each fuel cell may then be “stacked” with other cells to form a fuel cell stack in order to achieve the required voltage and power output.

In operation, fuel is introduced on the anode side of the cell through flow field channels formed on the surfaces of the conductive separator plates. The channels uniformly distribute fuel across the gas diffusion backing over the active area of the cell. The fuel then passes through the gas diffusion backing of the anode and travels to the anode catalyst layer where it reacts with the catalysts coated on the gas diffusion electrodes at the anode side and generates electrons and protons. Air or oxygen is introduced on the cathode side of the cell, which travels through the gas diffusion backing of the cathode to the cathode catalyst layer. Both catalyst layers are porous structures that contain precious metal catalysts, carbon particles, ion-conducting NAFION® particles, and, in some cases, specially engineered hydrophobic and hydrophilic regions. At the anode side, the fuel is electrochemically oxidized to produce protons and electrons. The protons must travel from the anode side, across the ion-conducting electrolyte membrane, and finally to the cathode side in order to react with the oxygen at the cathode catalyst sites. The electrons produced at the anode side must be conducted through the electrically conducting porous gas diffusion backing to the conducting separator plates. As soon as the separator plate at the anode is connected with the separator plate at the cathode via an external circuit, the electrons will flow from the anode through the circuit to the cathode. The oxygen at the cathode side will combine protons and electrons to form water as the by-product of the electrochemical reaction. The by-products must be continually removed via the separator plate at the cathode side in order to sustain efficient operation of the cell. Water is the only by-product if hydrogen is used as the fuel while water and carbon dioxide are the by-products if methanol is used as the fuel.

The cost of PEM fuel cells must be reduced dramatically to become commercially viable on a larger scale. The cost of the separator plates represents a significant portion of the total cost within a fuel cell. Therefore, cost reduction of the separator plate is imperative to enable PEM fuel cells to become commercially viable on a larger scale. The cost reduction can be manifested in several ways including reducing the cost of the materials that are used to make the plate, reducing the manufacturing cost associated with making the plate, and/or improving the function/performance of the plate within a fuel cell so that the same fuel cell can produce electrical power more efficiently and/or produce more electrical power within the same fuel cell. Typically, developments in the separator plate have attempted to optimize the trade-offs by reducing material cost and/or manufacturing cost while compromising performance-in-use.

Flow field separator plates are the outer components of each fuel cell and are in contact with the gas diffusion backing layers. The separator plates are called bipolar plates when used in a bipolar fuel cell stack. The separator plates perform many functions that place unusual demands on their materials of construction. Separator plates have flow field channels formed on their surfaces, which are precision-engineered channels designed to optimize fluid flow across the active area of the fuel cell and thereby increase fuel cell performance. Dramatic gains in kW per m² power density achieved over the past decade are due in large part to improved flow field channel design. Separator plates also conduct electrons and heat from the active layer to an external load and must maintain this conductivity over a long operating life in a highly corrosive environment. Both electrical and thermal conductivity at the interface between the gas diffusion backing and the separator plate are critical for minimising fuel cell resistance. Separator plates further provide physical separation of the oxidant and fuel in a bipolar fuel cell stack design and must maintain this separation throughout the lifetime of the stack to ensure a safe operation.

Therefore, separator plates provide structural integrity within each fuel cell and within the fuel cell stack as a whole. Structural integrity is essential to a fuel cell stack in order to maintain adequate seals within each fuel cell for the lifetime of the fuel cell stack. Structural integrity is also important to provide uniform compressive stress across the active area of the fuel cell and thereby maintain optimum performance of the fuel cell stack. Because of their multi-purpose role in a fuel cell, separator plates have a number of requirements to meet. Separator plates should have good electrical conductivity, good mechanical or structural properties and high chemical stability in the chemically reactive fuel cell environment. Because of their gas distribution role, separator plates should preferably be made of a gas impermeable material and be formed with complex gas delivery flow field channels across their surfaces.

Because of the performance requirements of conductive separator plates and the aggressive conditions inside the fuel cell, the material options for constructing conductive flow field plates are limited. In general, graphite has been used for conductive flow field plates because of its high electrical conductivity and resistance to corrosion. Graphite however is typically produced in 6 mm thick slabs, adding both weight and bulk to the fuel cell and decreasing its power density when in use. Further, machining flow fields onto graphite plates is not cost effective.

Past attempts at solving the various requirements for fuel cell plates have also included the use of metal plates, however, using metal results in higher weight per cell, higher machining costs and possibly corrosion problems.

Carbon/graphite filled conductive polymer composites made with plastic polymers as binders have long been identified as a promising alternative to traditional materials in separator plates. In principle, such compositions can be molded directly into complex, intricate shaped components using low cost, high speed molding processes. In U.S. Pat. No. 4,339,322 there is disclosed a bipolar current collector plate for electrochemical cells comprising a molded aggregate of graphite and a thermoplastic fluoropolymer particles reinforced with carbon fibres to increase strength and maintain high electrical conductivity.

Currently, the ability to use inexpensive and thin separator plates is critical for fuel cell stack cost reduction. However, a separator plate with a thickness of less than 3 mm often breaks easily because of insufficient flexural strength during stack assembly and fuel cell operation. Therefore there is a need to develop thin separator plates having sufficient flexural and mechanical strength to be used in PEM fuel cell stacks.

The prior art includes uses of screens and meshes in fuel cell applications. For example, U.S. published patent application 2002/0065000 discloses conductive plates for fuel cells. The plates include a substrate in the form of a mesh on which is placed one or more layers of resin on each side of the mesh. The plates also include protrusions made of black lead paint, and the protrusions fit within the openings in the mesh. Both the mesh and the resin are made of non-conductive materials.

U.S. Pat. No. 5,482,792 discloses the use of deformable current collectors in combination with bipolar separator plates. The collectors have high porosity and may be made from a screen or mesh.

U.S. Pat. No. 6,207,310 discloses a fuel cell assembly comprising a metal mesh that defines the flow field pattern. The bipolar plate is made of a three-layer structure having a thin metal foil between two metal meshes.

U.S. Pat. No. 4,855,193 relates to a method of removing water formed in a fuel cell by placing an electrically conductive screen between the wet-proofed carbon sheet and the bipolar separator plate.

U.S. Pat. Nos. 4,141,801, 4,237,195 and 4,314,231 all relate to new electrodes for use in fuel cells, rather than to separator plates. The electrodes include a porous, conductive screen or mesh.

U.S. patent applications 2001/0033959 and 2002/0064709 are related and disclose electrodes for fuel cells, in which current collectors in the form of metal meshes may be used together with the electrodes. The meshes also provide support for the electrodes.

The disclosures of all patents/applications referenced herein are incorporated herein by reference.

There remains a need in fuel cell applications for relatively thin separator plates having good conductivity and flexural strength.

### SUMMARY OF THE INVENTION

In one aspect of the present invention, separator plates made from conductive polymeric composites are provided that are reinforced with an electrically conductive mesh or screen. The conductive mesh or screen provides increased flexural strength so that the plates can be made as thin as less than 2.6 mm thick. At the same time, the preferred separator plates of the present invention are cheaper to make because the conductive polymeric composite can be made without using graphite fibers, which offer strong mechanical strength for the plate but are very expensive. Most or all of the expensive graphite fibers can be replaced with less expensive graphite powders since the graphite fibers are no longer needed to provide strength to the plates due to the inclusion of the conductive mesh.

Therefore, in accordance with one aspect of the present invention, there is provided a separator plate for use in fuel cells comprising a conductive polymeric composite reinforced with an electrically conductive mesh or screen. The electrically conductive mesh or screen is typically made of a metal or its alloy selected from the group consisting of iron, plain steel, stainless steel, copper, aluminium, silver, nickel, brass, bronze, gold, titanium and platinum. It can also be made of non-metallic conductive materials such as carbon fiber mesh, graphite fiber mesh and conductive ceramic mesh.

In accordance with a second aspect of the present invention, there is provided a method of manufacturing a conductive separator plate for use in fuel cells wherein the separator plate comprises a conductive polymeric composite and an electrically conductive mesh or screen, the method comprising the steps of:

a. mixing and compounding a polymer and conductive fillers to form a homogeneous blend (also called as composite), and

b. molding the blend to form the conductive separator plate, wherein the conductive polymeric composite is reinforced with the electrically conductive mesh or screen.

In a further embodiment, the molding step further comprises the following steps:

a. pre-molding the blend into two pre-molded plates,

b. placing the electrically conductive mesh between the two pre-molded plates, and

c. applying heat and pressure to the electrically conductive mesh and two pre-molded plates to form the conductive separator plate.

In yet a further embodiment, the molding step comprises the following steps:

a. placing a first layer of the compounded blend in a compression mold cavity,

b. laying the electrically conductive mesh over the first layer,

c. depositing a second layer of the blend over the electrically conductive mesh,

d. closing the mold, and

e. applying heat and pressure to the mold to form the separator plate.

### BRIEF DESCRIPTION OF THE DRAWINGS

The preferred embodiments of the present invention will be described with reference to the accompanying drawings in which like numerals refer to the same parts in the several views and in which:

FIG. 1 is a schematic view of a first method of making the preferred separator plates of the present invention.

FIG. 2 is a schematic view of a second method of making the preferred separator plates of the present invention.

### DETAILED DESCRIPTION OF THE PREFERRED EMBODIMENTS

In a preferred embodiment of the present invention, separator plates for use in PEM fuel cells comprise a conductive polymeric composite reinforced with a thin electrically and/or thermally conductive mesh or screen. The conductive mesh increases the flexural strength of the separator plates so that the plates can be made with a thickness of less than 2.6 mm. The inclusion of the conductive mesh into the separator plate provides many benefits, including:

a. The separator plates can be made thinner, but yet they retain sufficient flexural and mechanical strength.

b. The separator plates are cheaper to make since the use of expensive graphite fibers is reduced or eliminated.

c. Overall fuel cell/stack manufacturing costs are reduced.

d. The separator plates can be molded using fast speed molding processes.

The resulting thin separator plates of the present invention are electrically conductive and may be molded into square, rectangular or disc-shaped, elliptic or irregular shaped plates, with a total cross-sectional thickness preferably ranging from about 0.5 mm to about 2.6 mm. The separator plates can be molded with flat surfaces or they can be molded with flow field channels on one or both surfaces of the plates.

The separator plates comprise a conductive polymeric composite. The polymeric composites suitable for use in the present invention include all conductive thermoplastic, thermoset and elastomeric based composites that are useful in a PEM fuel cell operation environment. A well-known example is a blend of at least one polymer resin such as a liquid crystalline polymer with one type of electrically conductive filler such as graphite powder. Other examples of useful conductive polymeric composites are disclosed in the prior art as follows.

U.S. Pat. No. 4,098,967 provides thermoplastic resin filled with 40-80% by volume of finely divided vitreous carbon. Plastics employed in the compositions include polyvinylidene fluoride and polyphenylene oxide. The separator plates formed using this resin possess a specific resistance on the order of 0.002 ohm-cm. U.S. Pat. No. 3,801,374 discloses plates made from compression molding solution blends of graphite powder and polyvinylidene fluoride.

U.S. Pat. No. 4,214,969 discloses a separator plate fabricated by pressure molding a dry mixture of carbon or graphite particles and a fluoropolymer resin. The carbon or graphite particles are present in a weight ratio to the polymer of between 1.5:1 and 16:1. The polymer concentration is in the range of 6-28% by weight.

U.S. Pat. No. 4,554,063 discloses separator plates consisting of graphite (synthetic) powder of high purity having particle sizes in the range from 10 micron to 200 micron and irregularly distributed carbon fibers having lengths from 1 mm to 30 mm. The graphite powder/carbon fiber mass ratio is in the range from 10:1 to 30:1. The polymer resin used is polyvinylidene fluoride.

U.S. Pat. No. 5,582,622 discloses separator plates comprising a composite of long carbon fibers, a filler of carbon particles and a fluoroelastomer.

There are a number of other patents that describe methods for manufacturing current collectors of particular formulations or the formulations themselves. Among these is U.S. Pat. No. 4,839,114, which discloses a composition that includes 35-45% of carbon black fill, and optionally not more than 10% by weight carbon fibers as part of the fill. U.S. Pat. No. 5,942,347 describes a separator plate comprising at least one electronically conductive material in an amount of from about 50% to about 95% by weight of the separator plate, at least one resin in an amount at least about 5% by weight of the separator plate and the hydrophilic agent. The conductive material can be selected from carbonaceous materials including graphite, carbon black, carbon fibers and mixtures thereof.

In U.S. Pat. No. 6,180,275 and in PCT International Publication Nos. WO 00/30202 and WO 00/30203, there are described molding compositions for providing separator plates that include conductive fillers in various forms, including powder and fiber. High purity graphite powder is preferred having a carbon content of greater than 98%. The graphite powder preferably has an average particle size of approximately 23 to 26 microns and a BET-measured surface area of approximately 7-10 m²/g. The preferred composition contains 45-95 weight percent graphite powder, 5-50 weight percent polymer resin and 0-20 weight percent metallic fiber, carbon fiber and/or carbon nanofiber.

U.S. Pat. No. 6,248,467 describes a separator plate molded from a thermal setting vinyl ester resin matrix having a conductive powder embedded therein. The powder may be graphite having particle sizes predominantly in the range of 80-325 mesh. Reinforcement fibers selected from graphite/carbon, glass, cotton and polymer fibers are also described. The patent indicates that the presence of graphite fibers does not produce improved conductivity, although it does contribute to flexural strength.

In published European Patent Application 0,593,408 there is described a composition for forming a separator plate that includes graphite particles as a filler. Organic or inorganic fibers may be used. The patent application indicates that when the amount of filler is in the range of 100-2000 parts by weight, the resulting separator plate can have lower electrical resistance and better mechanical strength.

Other examples of conductive polymeric composite are provided in co-pending U.S. application serial No. 60/357,037 filed Feb. 13, 2002 and assigned to the Applicant herein. This application discloses a composition comprising from about 10 to about 50% by weight of a polymer (selected from thermoplastic and thermosetting plastics and elastomers); from about 10 to about 70% by weight of a graphite fibre filler having a length of from about 15 to about 500 microns; and from 0 to about 80% by weight of a graphite powder filler having a particle size of from about 20 to about 1500 microns. Suitable polymers are copolymers of tetrafluoroethylene with perfluoropropylene, copolymers of tetrafluoroethylene with perfluoroalkylvinylethers, copolymers of ethylene and tetrafluoroethylene, polyvinylidene fluoride, polychlorotrifluoroethylene, etc., polyolefins like polyethylene or polypropylene, cycloolefin copolymers like norbylideneethylene copolymers and other copolymers of this type manufactured with metallocene catalysts, polyamides, thermoplastically workable polyurethanes, silicones, novolaks, polyaryl sulfides like polyphenylenesulfide, polyaryletherketones which have a permanent temperature resistance according to DIN 51 005 of at least 80° C. Polymers having a polyvinylidene and cycloolefin basis are preferably used. Also useful are aromatic thermoplastic liquid crystalline polymers such as polyesters, poly(ester-amides), poly(ester-imides), and polyazomethines. Also useful are a blend of two or more aromatic thermoplastic liquid crystalline polymers, or a blend of an aromatic thermoplastic liquid crystalline polymer with one or more non-aromatic thermoplastic liquid crystalline polymers wherein the aromatic thermoplastic liquid crystalline polymer is the continuous phase.

The second component of the conductive polymeric composite is conductive fillers. The conductive fillers useful in the present invention include conductive graphite powders, graphite fibers, carbon black, carbon fibers, conductive ceramic fillers, metal fillers, metal-coated fillers and inherent conductive polymers. As specific examples of graphite, there can be mentioned natural graphite, synthetic graphite and graphite powder. Preferably, the use of expensive graphite fibers is reduced or eliminated, and instead more graphite powder is used since the electrically conductive mesh gives the separator plate the needed flexural and mechanical strength.

The conductive polymeric composite is preferably made from a blend having the following composition, without including the weight of the conductive mesh: from about 10 wt % to about 50 wt %, more preferably from about 20 wt % to about 30 wt %, of the plastic component and from about 50 wt % to about 90 wt %, preferably from about 70 wt % to about 80 wt %, of the conductive filler component.

The conductive mesh suitable for use in the present invention includes any metal-based, carbon-based, graphite-based and conductive ceramic-based mesh or screen. Preferably the conductive mesh is made of iron, plain steel, stainless steel, copper, aluminium, silver, nickel, brass, bronze, gold, titanium and platinum. The electrically conductive mesh can be manufactured in different ways such as from woven wire cloth, welded wire cloth, knitted wire screen, perforated thin sheet and molded screen. The open area of the mesh should be big enough to allow the polymer melt to pass through the hole from one side to another side of the mesh. The open area of the mesh is in the range of from 10% to 90% based on the total mesh size and preferably in the range of from 30%-80%. The numbers of mesh per linear inch is in the range from 2×2 to 600×600 and preferably in the range from 12×12 to 60×60. The total thickness of the mesh is in the range of from 0.001 inch to 0.1 inch and preferably in the range of from 0.006 inch to 0.015 inch. The mesh is electrically conductive to allow the separator plate to conduct current. As well the conductive mesh provides flexural and mechanical strength to the separator plate, and may also provide thermal conductivity to assist in removing heat from the fuel cell. The overall length and width of the conductive mesh can be larger than, the same as or smaller than the overall size of the separator plate, but it should preferably not be smaller than the active area of the flow field area on the plate. For corrosion protection and appearance reasons, it is preferred that the mesh is completely embedded within the formed separator plate and that none of it is exposed to the fuel cell's corrosive environment. For some other reasons, however, the mesh size might be bigger than that of the plate.

The preferred separator plates of the present invention are made by compounding the polymer and the conductive filler into a homogeneous blend and then molding the blend into a shaped conductive separator plate with the conductive mesh embedded into the conductive composite.

Compounding is done by mixing (dry-blending or otherwise) the plastic resin, conductive filler and any optional additives (such as a crosslinking agent) via a compounding machine such as a twin-screw extruder (for example a ZSK extruder from Coperion US), a continuous compounding kneader (for example a BUSS Kneader from Coperion US) or a batch mixer (such as a BRABENDER® or BANBURY® mixer). Preferably, compounding is done at a temperature in the range of from about 120° C. to about 400° C., preferably from about 150° C. to about 350° C.

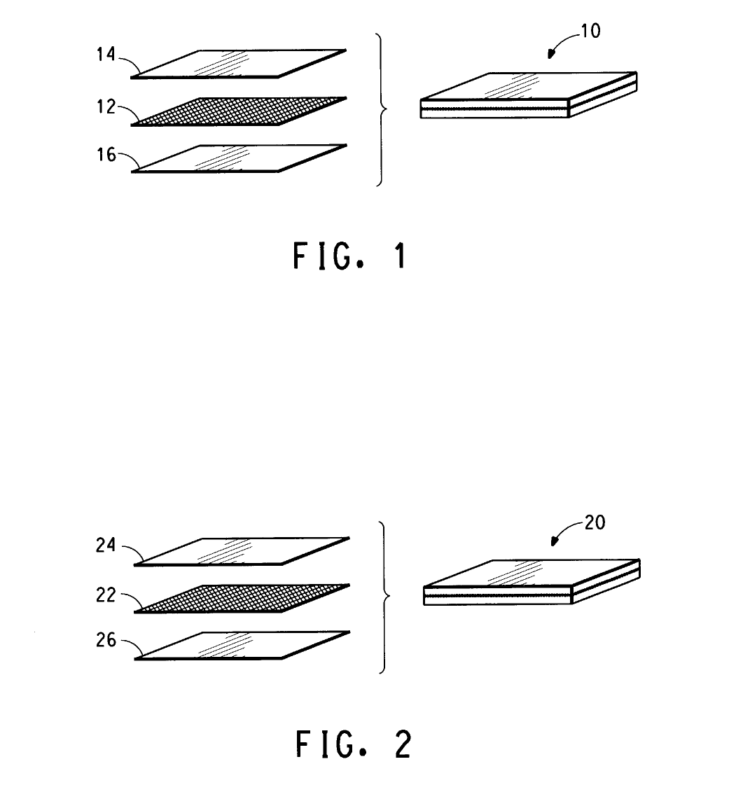

In accordance with a further aspect of the present invention, there are two molding methods that may be used. FIG. 1 illustrates the first method, Method A, in which two thin flat plates 14 and 16 are pre-molded using the compounded blend. The conductive mesh 12 is then placed between the two pre-molded plates and heat and pressure are applied to bond the two plates and mesh into one structure to form the separator plate 10.

FIG. 2 illustrates the second method, Method B. A first thin layer 26 of the compounded blend is first placed in a compression mold cavity (not shown). The conductive mesh 22 is laid over the first thin layer 26 and a second thin layer 24 of the blend is then deposited on top of the conductive mesh 22. The mold is closed and sufficient heat and pressure are then applied on the mold to form the separator plate 20. The mold is then cooled and the formed plate removed.

Molding is preferably carried out using a temperature in the range from about 120° C. to about 400° C., preferably from about 150° C. to about 350° C., and a pressure in the range of from about 200 psi to about 6000 psi, preferably from 500 psi to 2000 psi.

Other known molding procedures are also suitable for use in making the separator plates of the present invention. These known procedures may include injection molding, co-injection molding, insert injection molding, injection-compression molding, back injection molding, coining, extrusion, co-extrusion, transfer molding, extrusion-transfer-pressing, calendaring, coating, laminating, etc.

Preferably, the resulting shaped electrically conductive article has a bulk resistivity of less than about 0.5 ohm.cm, and a thickness of less than about 2.6 mm. These shaped electrically conductive articles can be used as separator plates for application in PEM fuel cells, batteries and other electrochemical devices.

### EXAMPLES

### Example 1

A conductive polymeric composite was prepared containing the following three components:

50 wt % synthetic graphite powder sold as THERMOCARB® CF300 (available from Conoco, USA),

20 wt % milled graphite fiber having an average length of 200 μm (available from Conoco, USA), and

30 wt % aromatic polyester liquid crystalline polymer sold as ZENITE® 800 (available from E. I. du Pont, USA).

The three components were in powder form and were dry-blended in a tumbling blender at room temperature and thereafter compounded via a ZSK25 WSE co-rotating twin screw extruder from Coperion at 300° C. processing temperature. The compounded crumb-like blend was used to mold mesh-reinforced plates using the following compression molding procedures.

Compression molding with Method A:

1 mm thin flat plates were made by depositing 25 grams of the compounded blend into a 4″×4″ mold cavity and heating the mold to 320° C. and applying 8000 lbs compression force on the mold for 2 minutes. The mold was then cooled down to 90° C., the pressure was released and the molded flat plates were removed from the mold.

An aluminium woven wire mesh (mesh per linear inch=18×12, wire diameter=0.0085 inches, open area=76%) having a size of 3.6″×3.6″ was placed between two of the thin flat plates made above. The three-layer structure was then molded in the same mold as above to form a 4″×4″ mesh-reinforced separator plate. FIG. 1 is a schematic illustration of the procedure of Method A.

The formed separator plates were measured for bulk resistivity using the standard Four Point Probe method and for flexural strength using the ASTM D790 method. The standard Four Point Probe method is performed in accordance with the method described in Wieder, H H, Laboratory Notes on Electrical and Galvanomagnetic Measurements, Material Science Monograph, Vol. 2, Elsevier Pub., Amsterdam, 1979, which is herein incorporated by reference. A current (I) is injected at the first of four linear equi-spaced point electrode probes and collected at the fourth electrode, while the potential difference (ΔV) between the second and third electrodes is measured. The resistivity (ρ) is determined using the following equation where T is the thickness of the sample, and R is the measured resistance.

ρ=4.53RT.

The results of the bulk resistivity and flexural strength measurements are shown in Table 1 below.

### Example 2

A conductive polymeric composite was prepared containing the following two components:

80 wt % synthetic graphite powder sold as THERMOCARB® CF300 (available from Conoco, USA),

20 wt % aromatic polyester liquid crystalline polymer sold as ZENITE® 800 (available from E. I. du Pont, USA)

The two components were in powder form and were dry-blended in a tumbling blender at room temperature and then compounded via a ZSK25 WSE co-rotating twin screw extruder from Coperion at 300° C. processing temperature. The compounded crumb-like blend was used to mold mesh reinforced separator plates with following compression molding procedures.

Compression molding with Method B:

25 grams of the compounded blend was deposited uniformly in a 4″×4″ mold cavity. A piece of 4″×4″ stainless steel mesh (type 304, mesh per linear inch=28×28, wire diameter=0.01 in., open area=51.8%) was laid on top of the deposited blend. Afterwards, a second layer of 25 grams of the same compounded blend was deposited on top of the stainless steel mesh. The mold was closed and heated to 320° C. 8000 lbs. compression force was applied on the mold for 2 minutes. The mold was then cooled down to 90° C., and the pressure released. The mold was opened and the molded flat separator plate was removed from the mold.

The resulting plates were measured for bulk resistivity with the standard Four Point Probe Method and for flexural strength with method ASTM D790. The results are shown in Table 1.

### Example 3

Separator plates were made in accordance with the procedure set out in Example 2, except that a piece of 4″×4″ copper mesh (mesh per linear inch=16×16, wire diameter=0.011 in., open area=67.9%) was used instead of stainless steel mesh. All other conditions were otherwise the same as in Example 2.

The resulting plates were measured for bulk resistivity with the standard Four Point Probe Method and for flexural strength with method ASTM D790. The results are shown in Table 1.

### Comparative Example A

Separator plates were made in accordance with the procedure set out in Example 1 above, except that no mesh was embedded into the plate. Thus, only the two 1 mm thin plates, without the mesh, were compression molded to form the separator plates. The resulting plates were measured for bulk resistivity with the standard Four Point Probe Method and for flexural strength with method ASTM D790. The results are shown in Table 1.

### Comparative Example B

Separator plates were made in accordance with the procedure set out in Example 2 above, except that no mesh was embedded into the plate. Thus, only the compounded blend, without the mesh, was compression molded to form the separator plates. The resulting plates were measured for bulk resistivity with the standard Four Point Probe Method and for flexural strength with method ASTM D790. The results are shown in Table 1.

TABLE 1

| | Total | | | | |
|---|---|---|---|---|---|
| | conduc- | | | | |
| | tive | Mesh | Total plate | Bulk | Flexural |
| | filler | reinforcement | thickness | resistivity | strength at |
| Example | (wt %) | used | (mm) | (Ω · cm) | yield (psi) |
| Ex. 1 | 70 | Aluminum | 1.6 | 0.078 | 5517 |
| Ex. 2 | 80 | Stainless | 2.6 | 0.006 | 5911 |
| | | steel | | | |
| Ex. 3 | 80 | Copper | 2.2 | 0.001 | 5430 |
| Comp. | 70 | No mesh | 2.0 | 0.069 | 4859 |
| Ex. A | | used | | | |
| Comp. | 80 | No mesh | 2.6 | 0.009 | 5063 |
| Ex. B | | used | | | |

Although the present invention has been shown and described with respect to its preferred embodiments and in the examples, it will be understood by those skilled in the art that other changes, modifications, additions and omissions may be made without departing from the substance and the scope of the present invention as defined by the attached claims.

What is claimed is:

1. A separator plate for use in fuel cells comprising a conductive polymeric composite reinforced with an electrically conductive mesh or screen.

2. The separator plate of claim 1, wherein the electrically conductive mesh is made of a metal or its alloy selected from the group consisting of iron, plain steel, stainless steel, copper, aluminum, silver, nickel, brass, bronze, gold, titanium and platinum, or is made of a non-metallic conductive material selected from the group consisting of carbon, graphite and conductive ceramics.

3. The separator plate of claim 1, wherein the electrically conductive mesh has a number of mesh per linear inch in the range of from about 2×2 to about 600×600.

4. The separator plate of claim 1, wherein the electrically conductive mesh has a number of mesh per linear inch in the range of from about 12×12 to about 60×60.

5. The separator plate of claim 1, wherein the electrically conductive mesh has a total thickness in the range of from about 0.001 inch to about 0.1 inch.

6. The separator plate of claim 1, wherein the electrically conductive mesh has a total thickness in the range of from about 0.006 inch to about 0.015 inch.

7. The separator plate of claim 1, wherein the electrically conductive mesh has an open area in the range of from about 10% to about 90% based on the total mesh size.

8. The separator plate of claim 1, wherein the electrically conductive mesh has an open area in the range of from about 30% to about 80% based on the total mesh size.

9. The separator plate of claim 1, wherein the conductive polymeric composite comprises a polymer and conductive fillers.

10. The separator plate of claim 9, wherein the polymer is selected from the group consisting of thermoplastic, thermoset and elastomeric resins.

11. The separator plate of claim 9, wherein the polymer is selected from the group consisting of liquid crystalline polymer, polyvinylidene fluoride, polyphenylene oxide, fluoropolymer resins, fluoroelastomer, copolymers of tetrafluoroethylene with perfluoropropylene, copolymers of tetrafluoroethylene with perfluoroalkylvinylethers, copolymers of ethylene and tetrafluoroethylene, polychlorotrifluoroethylene, polyolefins, cycloolefin copolymers, copolymers manufactured with metallocene catalysts, polyamides, thermoplastically workable polyurethanes, silicones, novolaks, polyaryl sulfides, polyaryletherketones that have a permanent temperature resistance according to DIN 51 005 of at least 80° C., polymers having a polyvinylidene and cycloolefin basis, polyesters, poly(ester-amides), poly(ester-imides), polyazomethines, a blend of two or more aromatic thermoplastic liquid crystalline polymers, and a blend of an aromatic thermoplastic liquid crystalline polymer with one or more non-aromatic thermoplastic liquid crystalline polymers wherein the aromatic thermoplastic liquid crystalline polymer is the continuous phase.

12. The separator plate of claim 9, wherein the conductive fillers are selected from the group consisting of conductive graphite powders, graphite fibers, carbon black, carbon fibers, conductive ceramic fillers, metal fillers, metal-coated fillers, inherent conductive polymers and mixtures thereof.

13. The separator plate of claim 12, wherein the conductive graphite powders and graphite fibers are natural or synthetic graphite.

14. The separator plate of claim 9, wherein the conductive polymeric composite comprises from about 10 wt % to about 50 wt % of the plastic and from about 50 wt % to about 90 wt % of the conductive filler.

15. The separator plate of claim 9, wherein the conductive polymeric composite comprises from about 20 wt % to about 30 wt % of the plastic and from about 70 wt % to about 80 wt % of the conductive filler.

16. The separator plate of claim 9, wherein the conductive filler comprises from about 70 wt % to about 100 wt % of graphite powder and from about 0 wt % to about 30 wt % of graphite fibers, based on the total weight of the conductive filler component.

17. The separator plate of claim 1, wherein the conductive mesh has a width and length that is larger than, equal to or smaller than the width and length of the separator plate.

18. The separator plate of claim 1, wherein the conductive mesh is completely embedded into the conductive polymeric composite.

19. The separator plate of claim 1, wherein the separator plate has a bulk resistivity of less than about 0.5 ohm.cm, and a thickness of less than about 2.6 mm.

20. A method of manufacturing a conductive separator plate for use in fuel cells wherein the separator plate comprises a conductive polymeric composite and an electrically conductive mesh or screen, the method comprising the steps of:
(a) mixing and compounding a polymer and conductive fillers to form a homogeneous blend, and
(b) molding the blend to form the conductive separator plate, wherein the conductive polymeric composite is reinforced with the electrically conductive mesh or screen.

21. The method of claim 20, wherein the compounding is done at a temperature in the range of from about 120° C. to about 400° C.

22. The method of claim 20, wherein the compounding is done at a temperature in the range of from about 150° C. to about 350° C.

23. The method of claim 20, wherein the molding is done at a temperature in the range from about 120° C. to about 400° C., and a pressure in the range of from about 200 psi to 6000 psi.

24. The method of claim 20, wherein the molding is done at a temperature in the range from about 150° C. to about 350° C., and a pressure in the range of from about 500 psi to 2000 psi.

25. The method of claim 20, wherein the molding step (b) comprises the following steps:
(c) ©pre-molding the blend into two pre-molded plates,
(d) placing the electrically conductive mesh between the two pre-molded plates, and
(e) applying heat and pressure to the electrically conductive mesh and two pre-molded plates to form the conductive separator plate.

26. The method of claim 20, wherein the molding step comprises the following steps:
(a) placing a first layer of the compounded blend in a compression mold cavity,
(b) placing the electrically conductive mesh over the first layer,
(c) depositing a second layer of the blend over the electrically conductive mesh,
(d) closing the mold, and
(e) applying heat and pressure to the mold to form the separator plate.

27. The method of claim 20, wherein the molding step is done by a molding procedure selected from the group consisting of compression molding, insert compression molding, injection molding, co-injection molding, insert injection molding, injection-compression molding, back injection molding, coining, extrusion, co-extrusion, transfer molding, extrusion-transfer-pressing, calendering, coating and laminating.

28. The method of claim 20, wherein the separator plate has a bulk resistivity of less than about 0.5 ohm.cm, and a thickness of less than about 2.6 mm.

29. The method of claim 20, wherein the electrically conductive mesh is made of a metal or alloy selected from the group consisting of iron, plain steel, stainless steel, copper, aluminum, silver, nickel, brass, bronze, gold, titanium and platinum or is made of a non-metallic conductive material selected from the group consisting of carbon, graphite and conductive ceramics.

30. The method of claim 20, wherein the electrically conductive mesh has a number of mesh per linear inch in the range of from about 2×2 to about 600×600.

31. The method of claim 20, wherein the electrically conductive mesh has a number of mesh per linear inch in the range of from about 12×12 to about 60×60.

32. The method of claim 20, wherein the electrically conductive mesh has a total mesh thickness in the range of from about 0.001-inch to 0.1 inch.

33. The method of claim 20, wherein the electrically conductive mesh has a total mesh thickness in the range of from about 0.006 inch to about 0.015 inch.

34. The method of 20, wherein the conductive polymeric composite comprises a polymer and conductive fillers.

35. The method of claim 34, wherein the polymer is selected from the group consisting of thermoplastic, thermoset and elastomeric resins.

36. The method of claim 34, wherein the polymer is selected from the group consisting of liquid crystalline polymer, polyvinylidene fluoride, polyphenylene oxide, fluoropolymer resins, fluoroelastomer, copolymers of tetrafluoroethylene with perfluoropropylene, copolymers of tetrafluoroethylene with perfluoroalkylvinylethers, copolymers of ethylene and tetrafluoroethylene, polychlorotrifluoroethylene, polyolefins, cycloolefin copolymers, copolymers manufactured with metallocene catalysts, polyamides, thermoplastically workable polyurethanes, silicones, novolaks, polyaryl sulfides, polyaryletherketones that have a permanent temperature resistance according to DIN 51 005 of at least 80° C., polymers having a polyvinylidene and cycloolefin basis, polyesters, poly(ester-amides), poly(ester-imides), polyazomethines, a blend of two or more aromatic thermoplastic liquid crystalline polymers, and a blend of an aromatic thermoplastic liquid crystalline polymer with one or more non-aromatic thermoplastic liquid crystalline polymers wherein the aromatic thermoplastic liquid crystalline polymer is the continuous phase.

37. The method of claim 34, wherein the conductive fillers are selected from the group consisting of conductive graphite powders, graphite fibers, carbon black, carbon fibers, conductive ceramic fillers, metal fillers, metal-coated fillers, inherent conductive polymers and mixtures thereof.

38. The method of claim 37, wherein the conductive graphite powders and graphite fibers are natural or synthetic graphite.

39. The method of claim 34, wherein the conductive polymeric composite comprises from about 10 wt % to about 50 wt % of the plastic and from about 50 wt % to about 90 wt % of the conductive filler.

40. The method of claim 34, wherein the conductive polymeric composite comprises from about 20 wt % to about 30 wt % of the plastic and from about 70 wt % to about 80 wt % of the conductive filler.

41. The method of claim 39, wherein the conductive filler comprises from about 70 wt % to 100 wt % of graphite powder and from about 0 wt % to about 30 wt % of graphite fibers, based on the total weight of the conductive filler component.

42. The method of claim 20, wherein the conductive mesh has a width and length that is larger than, equal to or smaller than the width and length of the separator plate.

43. The method of claim 20, wherein the conductive mesh is completely embedded into the conductive polymeric composite.

44. The method of claim 20, wherein the separator plate has a bulk resistivity of less than about 0.5 ohm.cm, and a thickness of less than about 2.6 mm.
